(19) United States
(12) Patent Application Publication
(10) Pub. No.: US 2006/0162090 A1
(43) Pub. Date: Jul. 27, 2006

(54) Odor-absorbing cellulosic fibrous substrates

(76) Inventor: David A Offord, Castro Valley, CA (US)

Correspondence Address: MORRISON & FOERSTER LLP, 755 PAGE MILL RD, PALO ALTO, CA, 94304-1018, US

(21) Appl. No.: 10/534,547

(22) PCT Filed: Oct. 29, 2003
(86) PCT No.: PCT/US03/34435

§ 371 Date: Nov. 23, 2005

Related U.S. Application Data
(60) Provisional application No. 60/423,786, filed on Nov. 5, 2002.

(51) Int. Cl. C11D 3/00

(52) U.S. Cl. 8/115.51

(57) ABSTRACT

The present invention is directed to durable finishes for cellulose-containing fibers and fibrous substrates. The active components of the finishes are hydroxyl-containing amines, and preferably trialkanol amines. When combined with a suitable crosslinker, the amines become attached to and crosslinked on the substrate fiber, and form a soft resinous coating that is durable to cleaning procedures. This polymeric coating imparts durable anti-microbial activity and renewable control of certain odors.

### FIELD OF THE INVENTION

This invention is directed towards cellulosic fibers of fabric or other fibrous substrates coated with amines.

### BACKGROUND OF THE INVENTION

Fabrics composed of only natural (e.g. cotton, wool, silk) or synthetic (e.g. polyester, nylon, acrylic) fibers are often lacking in desirable attributes. It is common in the textile industry to add a small weight component of various chemicals to the fabric to impart desired properties; these treatments are commonly referred to as “finishes”. Such chemical enhancers include dyes, optical brighteners, softeners, water repellents, water/oil repellents, insect repellents, anti-microbial and/or anti-fungal treatments, anti-static finishes, and hydrophilic finishes.

Durability is simultaneously a desired property and a significant challenge for any finish. Even molecules with only slight volatility will eventually evaporate; sunlight and air will slowly degrade others. Cleaning procedures such as laundering, dry-cleaning, and shampooing are the most significant challenges to fabric finish durability. Many finishes are removed from fabrics after only a few cleanings.

Various approaches have been taken to provide durable finishes. One method is to deposit chemicals (typically polymers) that are not readily solubilized and washed away after being precipitated onto the fabric. Alternatively, the active ingredient of a finish may be embedded in a laminant film that is applied to fabric; this procedure often allows for the slow release of the active ingredient into the surrounding fabric. However, the detergents and mechanical agitation of conventional cleaning procedures often eventually remove the polymer or laminant film when it is merely deposited onto the fiber surface.

U.S. Pat. No. 6,187,856, issued to Incorvia et al, teaches the use of crosslinked resins, formed from polyamidoamines and polychlorohydrin crosslinkers, to form durable films on fabrics. The resins of this patent are claimed to give durable anti-static properties to the fabric. Durability is defined in this patent as evidence of anti-static properties after dipping treated fabric into water heated at 80° C. for two twenty-minute intervals.

Anti-microbial finishes are highly desirable for many textile applications. They may be employed on fabrics used in settings requiring antiseptic conditions, such as in hospitals. They may also be useful for fabrics worn or used in commercial food preparation, hospitality settings, and other areas where there is the significant potential of exposing people to infectious bacteria.

There are only a handful of classes of anti-microbial compounds. Durability is a significant problem for them, as most are small molecules that evaporate readily or can be washed away. Moreover, many anti-microbial compounds exhibit toxicity to humans. It would be desirable to invent a durable anti-microbial fabric finish that is innocuous to humans.

The ability to eliminate or significantly diminish malodorous axillary (body) odor and foot odor is a desirable attribute for apparel fabrics. The chemical components of axillary odor are the waste by-products of certain bacteria that live off of the secretions from human sweat glands. These species of bacteria are called lipophilic diptheroids. Some three dozen molecules with potentially offensive odors have been identified in body odor (see, Preti, G. et al, J. Chem. Ecology, 1991, 17, 1469; Preti, G. et al, J. Chem. Ecology, 1992, 18, 1039; Preti, G. et al, J. Chem. Ecology, 1996, 22, 237; Proc. Nat. Acad. Sci. USA, 1996, 93, 6626). All of them are organic acids and the main contributor to the odor has been identified as trans-3-methyl-2-hexenoic acid. The chemical components of foot odor have similar origin; they are waste products of the bacteria brevidium epidermis. These molecules are also organic acids, and the most significant component is isovaleric acid (see, Kanda, F. et al, Brit. J. of Dermatology, 1990, 122, 771). It would be desirable to have a durable finish that would eliminate or significantly diminish malodorous body odor on fabrics. One approach is to include a bacteriocidal finish. However, these may not kill bacteria living on the skin and so odor may still be produced. Another method is to use a finish that absorbs the malodorous organic acids responsible for axillary and foot odor so that the volatile concentrations of the offensive organic acids are below the threshold of detectability. It would be greatly desirable to be able to recharge the absorptive capacity of such a finish by standard cleaning procedures.

U.S. Pat. No. 4,244,059, issued to Pflaumer, teaches the use of an odor-absorbent compound selected from alkali metal bicarbonates, alkali metal carbonates, water-soluble polyamines derived from ethylenimine, and mixtures thereof. The compound is deposited over the surface of air-permeable fabric composed of cellulosic fibers, to adsorb acidic and basic odorous molecules which are the major components of crotch odors. The patent makes no claims as to durability, nor does it make provisions to provide for durability of the polymer to the fabric during common cleaning processes such as laundering.

International patent publication WO 97/34040, issued to Koizumi et al., teaches the use of polyamines as coatings for acrylic fibers to produce deodorizing fibers. In this patent, wet gel acrylic fibers containing acid groups are brought into contact with “an amino compound” with the stoichiometry adjusted so that there is an excess of amine groups. Electrostatic interactions between the amines and acid groups presumably are the source of durability. The fibers have been wet spun and not previously dried. After contacting the amine compound, the coated fiber is heated at between 100 and 180° C. under wet heat conditions. Fiber products constructed from these fibers are able to deodorize acidic odors.

### SUMMARY OF THE INVENTION

The present invention is directed to durable finishes for cellulose-containing fibers and fibrous substrates. The active components of the finishes are hydroxyl-containing amines, and preferably trialkanol amines. When combined with a suitable crosslinker, the amines become attached to and crosslinked on the substrate fiber, and form a soft resinous coating that is durable to cleaning procedures. These polymeric finishes impart durable anti-microbial activity, renewable control of certain odors, and the capacity to bind certain materials to the fabric surface.

This invention is further directed to the cellulosic fibers; yarns; woven, knitted or nonwoven fabrics and textiles; and finished goods (all of which are encompassed herein under the term “fibrous substrates”) treated with the hydroxyl-containing amine coating of the invention.

The fibrous substrates treated with the finish described herein take on properties that are not found in the native fabric, including the ability to eliminate or greatly diminish the most offensive component of malodorous body odor, while surprisingly reducing the yellowing of the substrates experienced with prior art amine treatments. Additionally, the treated cellulosic substrates remain hydrophilic and soft.

### DETAILED DESCRIPTION OF THE INVENTION

As used herein and in the appended claims, “a” and “an” mean one or more, unless otherwise indicated.

The terms “durable” and “durability” as used herein describe a finished fibrous substrate in which the desired properties imparted to the substrate by the finish are observed after multiple launderings or dry cleanings.

The “cellulose-containing” or “cellulosic” fibrous substrates to be treated according to the present invention include any cellulosic fiber and any blend of fibers that contains a cellulosic, whether as a majority or a minority component. Cellulosic-based substrates include paper, cotton, rayon and other regenerated cellulosics and cellulose-containing materials, linen, jute, ramie, industrial hemp, and the like. In a presently preferred embodiment, the cellulose-containing fiber or fibrous substrate is cotton.

The hydroxyl-containing amines for use in the invention may be primary, secondary or tertiary amines, or mixtures thereof, and may come from natural sources or from synthetic preparation. Tertiary amines are preferred because of their greatly reduced tendency to yellow compared to primary and secondary amines, which in turn exhibit reduced yellowing than that experienced with prior art amine treatments. Presently preferred embodiments of the invention include alkanol amines and preferably are selected from the tertiary amines of Formula (A): 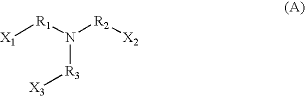
wherein, each of R₁, R₂ and R₃ is independently selected from lower alkyl groups, unsubstituted or substituted with one or more hydroxyl groups; and each of X₁, X₂ and X₃ is independently —OH or —H. Only one hydroxyl group per molecule is necessary for crosslinking of the molecule to the surface of the fibrous substrate. Having two or, preferably, all of X₁, X₂ and X₃ being hydroxyl groups, while not required, is desirable as it increases the likelihood of binding to the surface of the substrate and also allows crosslinking to other amines to improve the durability of the finish. By “lower alkyl groups” is meant alkyl groups, straight-chained or branched, having from one to eight carbon atoms.

Exemplary hydroxyl-containing amines useful in the present invention include, but are not limited to, triethanol amine; tris(hydroxymethyl)amino methane; 1-aza-3,3′-dioxabicyclo[3.3.0]octane-5-methanol; 1,3-bis[tris(hydroxymethyl)-methylamino]propane; and bis(2-hydroxyethyl)imino-tris(hydroxymethyl)methane.

The terms “crosslinkers” and “suitable crosslinkers” as used herein describes molecules that contain two or more hydroxyl-reactive functional groups that form bonds with the hydroxyl groups on the hydroxyl-containing amine and on the cellulosic fibrous substrates. The crosslinkers bind the hydroxyl-containing amines together, as well as to bind the hydroxyl-containing amines directly to the fiber surface. It is particularly desirable that the crosslinking reaction does not affect the basicity of the amines in the resulting coating. A catalyst may optionally be included to facilitate crosslinking. Hydroxyl-reactive functional groups include epoxides, halohydrins, oxiranes, carbonyl diimidazole, N,N′-disuccinimidyl carbonate or N-hydroxysuccinimidyl chloroformate, alkyl halogens, isocyanates, and N-methylol ureas. Preferred cross-linkers are diepoxides (Sigma-Aldrich corp.), N-methylol ureas, and blocked polyisocyanates such as Repearl MF (Mitsubishi Chemical Co.). Particularly preferred cross-linkers are the N-methylol ureas, such as dimethyloldihydroxyethyleneurea (DMDHEU) (PatCoRez P-53, BFGoodrich).

The finish that is applied to the fibrous substrate is a solution comprising at least a hydroxyl-containing amine, a crosslinker, and a volatile solvent. It is desirable that the amine and the crosslinker be soluble in the solvent. A particularly preferred solvent is water. The pad solution preferably contains hydroxyl-containing amine at between about 0.01% and about 75% by weight, more preferably about 0.05% and about 50% by weight, and most preferably about 0.1% and about 20% by weight. The pad solution preferably contains a crosslinker at between about 0.001% and about 40% by weight, more preferably about 0.01% and about 30% by weight, and most preferably about 0.05% and about 15% by weight. The finish solution may also include other components as described below.

The reaction of the hydroxyl-containing amine with certain crosslinker functional groups, such as halohydrins, results in the formation of mineral acids that lower the pH of the finish and may slow the rate and decrease the extent of crosslinking. To control this deleterious effect, a buffering agent may be added to the finish solution. Buffering agents are weak acids or bases that tend to hold solutions containing them within ±1 pH point of the buffering agents' pKₐ. One skilled in the art will appreciate that an optimal buffer solution consists of equimolar portions of the buffering agent and its corresponding conjugate acid or base, the latter often being formed by addition of a strong acid or base. Lists of buffering agents can be found in Lange's Handbook of Chemistry, 14^{th} edition, ed. J. A. Dean, McGraw-Hill, Inc., section 8, p.p. 103-112. If used, a buffering agent should be chosen so that the pKₐ of the buffer lies within the optimal pH range of the reaction. This pH range is dependent on the identities of the reactive group of the hydroxyl-containing amine and of the crosslinker. The buffer must also be chosen so as to be unreactive with the crosslinker or the hydroxyl-containing amine. The amount of buffering agent should be slightly more than equimolar to the theoretical total amount of acid generated by complete reaction of the crosslinker. The finish solution may also include other additives. For example, the finish solution may also contain a wetting agent, such as WetAid NRW (BF Goodrich Corp.), to aid the equal spread of the finish over the fibers. Additional additives can be added to the solution as needed and as known by those generally skilled in the art.

The finish can be applied to the cellulosic fibrous substrate by exposing the substrate to the finish solution by methods known in the art, such as soaking, spraying, dipping, fluid-flow, and padding. The exposed fibrous substrate is then heated to remove the volatile solvent and to speed up the reaction of the hydroxyl groups on the substrate and in the hydroxyl-containing amine with the crosslinker. Alternatively, the cellulosic fibers or yarns may be exposed to the finish solution by soaking, spraying or dipping. After the finish is cured in place, the fibers or yarns may be woven or knit into fabrics.

The finish solution may be applied to the fibrous substrate at any temperature above the freezing point and below the boiling point of the solvent. In the present embodiment, the application temperature is preferably between 5 and 90° C., more preferably between 10 and 50° C., and most preferably at room temperature. The treated fabric should be cured at a temperature high enough to induce the crosslinking reaction in a very short time, preferably less than five minutes, more preferably a minute or less. In the present embodiment, the curing temperature is preferably between 100 and 200° C., more preferably between 130 and 180° C.

The present invention is further directed to the cellulosic fibrous substrates treated with the finish described above. Substrates thus treated will possess properties not found in untreated substrates, while maintaining desirable properties such as a soft hand and hydrophilicity. These new properties include the ability to absorb malodorous organic acids via acid-base reactivity of the acids with the amine groups of the finish. The finishes of the invention are durable.

An embodiment of the present invention is the preparation of treated cellulosic fibrous substrates that absorb and deodorize organic acids, which gives such substrates the ability to eliminate or greatly diminish offensive body odor. The odor-absorbing capacity of the fabric can be recharged when necessary by conventional laundering procedures. The molecular sources of offensive body odor are primarily the waste products of a species of bacteria named lipophilic diphtheroids. This species of bacteria lives on the skin surface of humans and primarily digests the secretions of the apocrine glands. The malodorous waste products of lipophilic diphtheroids are organic acids, with the most significant component being 3-methyl-2-hexenoic acid. Volatile organic acids are commonly considered to have highly offensive odors even in extremely low concentrations.

The odor-absorptive capacity of the treated fibrous substrate stems from the basicity of the amine groups of the finish. Acids react with the free amine groups of the hydroxyl-containing amine to form non-volatile ionic complexes. The extent to which this ionic complexation occurs depends on the relative strength of the acid and base. In the case of the present invention, the reaction is biased towards formation of the ionic complex to such a degree that only between one acid molecule in ten thousand to one acid molecule in a million would be found in the non-ionized, potentially volatile form. Thus, as long as unreacted amine groups are available in the treated fabric, the concentration of volatilized organic acid around the treated fabric will be lowered to the point of being undetectable or scarcely detectable.

An advantage to the present invention over conventional odor-absorbing material such as activated carbon is the ability to recharge the odor-absorptive capacity of the fibrous substrate. As amines are weak bases, exposing the substrate to an aqueous solution with a pH at or above the pK_{b} of the base will deprotonate most of the amine complexes and result in separation of the amine-acid complexes. The conjugate base forms of the malodorous organic acids will be washed away in the laundry liquor, leaving behind free amine groups on the fiber surface. A pH of 10 is above the pK_{b} of most amines, and laundry detergent solutions such as Tide® typically have this pH or higher. Therefore, a conventional laundering procedure is normally sufficient to recharge the odor-absorptive capacity of the fabric.

The following examples are intended for illustrative purposes only. Those of skill in the art will recognize other embodiments, all of which are considered part of the present invention.

### EXAMPLES

### Example 1

Samples (16×12 inch square) of untreated cotton twill fabric were immersed in either a test solution (6.0 wt % triethanol amine, 10.0 wt % Patcorez P-53, and 0.25 wt % Wet Aid NRW in water, final pH=4.0; Sample A) or in a control solution (water only, final pH=4.0; Sample B), and padded at 30 psi. The samples were cured in a Mathis oven set at 330° F. (166° C.) overall temperature with a 310° F. (154° C.) trigger temperature for one minute. The whiteness of the resulting samples, compared to the untreated fabric, was measured using a UV-Vis integrating sphere following AATCC Test Method 110-2000. The samples were then home laundered (“HL”) using 24 g. of AATCC standard detergent in warm water on normal washer and dryer settings, after which the whiteness index was again measured. The results are shown in Table 1 below.

TABLE 1

| | Whiteness Index | | | | | |
|---|---|---|---|---|---|---|
| Sample | 0 HL | 1 HL | 5 HL | 10 HL | 15 HL | 20 HL |
| A | 71.14 | 67.36 | 75.98 | 76.98 | 77.78 | 76.93 |
| B | 74.43 | 73.98 | 82.13 | 82.65 | 84.08 | 84.40 |

Hydrophilicity/hydrophobicity tests were run on the samples by measuring the amount of time it takes for a drop of water to completely soak into the fabric. In all cases with both the treated and control samples, the time was less than 2 seconds.

Finally, a smell test was run by placing solutions of various concentrations (in ppm) of butyric acid on the fabric samples and recording the lowest concentration of butyric acid that is noticeable on the sample by a panel of judges. These results are presented in Table 2, below.

TABLE 2
Smell Test Results

| | Average minimum conc. (ppm) | | | | | |
|---|---|---|---|---|---|---|
| Sample | 0 HL | 1 HL | 5 HL | 10 HL | 15 HL | 20 HL |
| A | — | 750 | 750 | 775 | 850 | 600 |
| B | — | 38 | 50 | 63 | 50 | 38 |

What is claimed is:

1. A finish for a cellulosic fibrous substrate comprising i) primary, secondary or tertiary hydroxyl-containing amines, ii) a suitable crosslinker, and iii) a volatile solvent, wherein the finish provides anti-microbial properties to the fibrous substrate and wherein the finish is durable to cleaning procedures.

2. A finish for a cellulosic fibrous substrate comprising i) primary, secondary or tertiary hydroxyl-containing amines, ii) a suitable crosslinker, and iii) a volatile solvent, wherein the finish provides the fibrous substrate with the ability to eliminate or greatly diminish offensive body odor and wherein the finish is durable to cleaning procedures.

3. A finish according to claim 2 wherein the ability is rechargeable.

4. A finish according to claim 1, 2 or 3 wherein the hydroxyl-containing amines are alkanol amines selected from the group consisting of mono-, di-, and tri-alkanol amines.

5. A finish according to claim 4 wherein the alkanol amines are trialkanol amines.

6. A finish according to claim 5 wherein the trialkanol amines are selected from those of Formula (A): 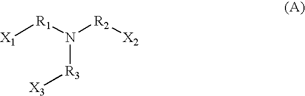
wherein, each of R₁, R₂ and R₃ is independently selected from lower alkyl groups, unsubstituted or substituted with one or more hydroxyl groups; and each of X₁, X₂ and X₃ is independently —OH or —H, with the proviso that at least one of X₁, X₂ or X₃ is —OH.

7. A treated cellulosic fibrous substrate having a finish comprising primary, secondary or tertiary hydroxyl-containing amines, which amines are crosslinked on the fiber surface of the fibrous substrate to form a resinous coating durable to cleaning procedures, the treated cellulosic fibrous substrate exhibiting durable anti-microbial properties.

8. A treated cellulosic fibrous substrate having a finish comprising primary, secondary or tertiary hydroxyl-containing amines, which amines are crosslinked on the fiber surface of the fibrous substrate to form a resinous coating durable to cleaning procedures, the treated cellulosic fibrous substrate exhibiting the durable ability to eliminate or greatly diminish offensive body odor.

9. A treated fibrous substrate according to claim 8 wherein the ability is rechargeable.

10. A treated fibrous substrate according to claim 7, 8 or 9 wherein the hydroxyl-containing amines are alkanol amines selected from the group consisting of mono-, di-, and tri-alkanol amines.

11. A treated fibrous substrate according to claim 10 wherein the alkanol amines are trialkanol amines.

12. A treated fibrous substrate according to claim 11 wherein the trialkanol amines are selected from those of Formula (A): 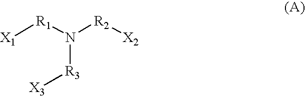
wherein, each of R₁, R₂ and R₃ is independently selected from lower alkyl groups, unsubstituted or substituted with one or more hydroxyl groups; and each of X₁, X₂ and X₃ is independently —OH or —H, with the proviso that at least one of X₁, X₂ or X₃ is —OH.

13. A method for providing anti-microbial properties to a cellulosic fibrous substrate, the method comprising:
exposing the fibrous substrate to a treatment composition comprising i) primary, secondary or tertiary hydroxyl-containing amines, ii) suitable crosslinker, and iii) a volatile solvent; and
curing the fibrous substrate;
to give a cellulosic fibrous substrate exhibiting durable anti-microbial properties.

14. A method for providing a cellulosic fibrous substrate with the ability to eliminate or greatly diminish offensive body odor, the method comprising:
exposing the fibrous substrate to a treatment composition comprising i) primary, secondary or tertiary hydroxyl-containing amines, ii) suitable crosslinker, and iii) a volatile solvent; and
curing the fibrous substrate;
to give a treated cellulosic fibrous substrate which exhibits the ability to durably eliminate or greatly diminish offensive body odor.

15. A method according to claim 14 which comprises the further step of exposing the treated fibrous substrate to an aqueous solution with a pH at or above 10, to recharge the odor-absorptive ability of the fibrous substrate.

16. A method according to any of claims 13 to 15 wherein the amines are partially reacted with the crosslinker prior to being placed in the volatile solvent.

17. A method according to any of claims 13 to 16 wherein the hydroxyl-containing amines are alkanol amines selected from the group consisting of mono-, di-, and tri-alkanol amines.

18. A method according to claim 17 wherein the alkanol amines are trialkanol amines.

19. A method according to claim 18 wherein the trialkanol amines are selected from those of Formula (A): 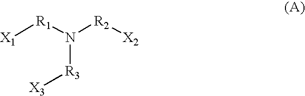
wherein, each of R₁, R₂ and R₃ is independently selected from lower alkyl groups, unsubstituted or substituted with one or more hydroxyl groups; and each of X₁, X₂ and X₃ is independently —OH or —H, with the proviso that at least one of X₁, X₂ or X₃ is —OH.
